(19) United States
(12) Patent Application Publication
(10) Pub. No.: US 2013/0273208 A1
(43) Pub. Date: Oct. 17, 2013

(54) Process for the Preparation of the Treated Water Fortified with the Micro Nutrients

(71) Applicants: Pradeep Poddar, Mumbai (IN); Henry Hidell, Hingham, MA (US); Shamik Bhattacharjee, Himachal Pradesh (IN)

(72) Inventors: Pradeep Poddar, Mumbai (IN); Henry Hidell, Hingham, MA (US); Shamik Bhattacharjee, Himachal Pradesh (IN)

(73) Assignee: Tata Global Beverages Limited, Kolkata (IN)

(21) Appl. No.: 13/825,784

(22) PCT Filed: Sep. 23, 2011
(86) PCT No.: PCT/IN11/00673

§ 371 Date: Jul. 2, 2013

(30) Foreign Application Priority Data
Sep. 23, 2010 (IN) 1069/KOL/2010

(51) Int. Cl. A23L 2/52

(52) U.S. Cl. CPC A23L 2/52
USPC 426/66

(57) ABSTRACT

A process for the preparation of the treated water fortified with the micro nutrients comprises pre-treating and sterilizing the water, resulting in a pure permeate. The said permeate is passed through ozonator for further sterilizing the water and thereafter it is de-ozonated to produce on line sterile water. The treated water is fortified with dosing at least one bio-available micro nutrient and/or sanitizing agent into the flowing water on line. The finished product must conform to the control drink preparation standards.

### FIELD OF THE INVENTION

The present invention provides a water treatment process. More particularly, it provides a process for the preparation of the treated water fortified with the micro nutrients to supplement the mineral deficiencies, which can be used for other blended beverages also.

### BACKGROUND OF THE INVENTION

Water purification is a process of removing undesirable chemicals, materials, and biological contaminants from raw water. In general, the conventionally used methods include physical processes such as filtration and sedimentation, biological processes such as slow sand filters or activated sludge, chemical processes such as flocculation and chlorination and the use of electromagnetic radiation such as ultraviolet light.

The purification process of water may reduce the concentration of particulate matter including suspended particles, parasites, bacteria, algae, viruses, fungi and a range of dissolved and particulate material derived from the surfaces that water may have made contact with after falling as rain.

Simple procedures such as boiling or the use of a household activated carbon filter are not sufficient for treating all the possible contaminants that may be present in water from an unknown source.

Further, distillation removes all minerals from water, and the membrane methods of reverse osmosis and nanofiltration remove mostly all the minerals. This result in demineralized water, which is not considered ideal drinking water. The World Health Organization has investigated the health effects of demineralized water. Experiments in humans found that demineralized water increased diuresis and the elimination of electrolytes, with decreased blood serum potassium concentration. Magnesium, calcium, and other minerals in water can help to protect against nutritional deficiency.

Demineralized water may also increase the risk from toxic metals because it more readily leaches materials from piping like lead and cadmium, which is prevented by dissolved minerals such as calcium and magnesium.

Micronutrients are nutrients needed throughout life in small quantities. They are dietary minerals needed by the human body in very small quantities (generally less than 100 micrograms/day) as opposed to macrominerals which are required in larger quantities. The Microminerals or trace elements include at least iron, cobalt, chromium, copper, iodine, manganese, selenium, zinc, boron and molybdenum.

Moreover, supplementing the mineral deficiencies through food is not always feasible due to different food habits of the subjects in different geographical locations. However, the same can be done through drinking water or other beverages.

Another method of sterilizing water is through Ozonation. O₃ is an unstable molecule which readily gives up one atom of oxygen providing a powerful oxidizing agent, which is toxic to most waterborne organisms. It is a very strong disinfectant that is widely used to inactivate harmful protozoa that form cysts. It also works well against almost all other pathogens. Ozone is made by passing oxygen through ultraviolet light or a “cold” electrical discharge. Ozone is used as an anti-microbiological agent for the treatment, storage, and processing of foods.

However, the main disadvantage of ozone is that it leaves no disinfectant residual in the water. Because there is no longer any disinfecting mechanism to follow the water throughout the distribution system, there is the possibility that bacteria will begin to re-grow in the water.

Other disadvantages of ozone treatment are that it can create undesirable by-products eg. formaldehyde and bromate, that can be harmful to health if they are not controlled.

Further, in the preparation of the treated water fortified with the micro nutrients, it is undesirable to have excess of ozone, as it is effective at removing dissolved minerals and salts.

Therefore, the object of the present disclosure is to provide a process for the preparation of the treated water fortified with the micro nutrients to supplement the mineral deficiencies, which can be used in other blended beverages also.

Further object of the present disclosure is to obviate the drawbacks of ozonation.

Another object of the present invention is to provide a SOP according to a control drink preparation.

Yet another object of the present disclosure is to provide treated water fortified with the micro-nutrients, which is in conformity with control drink SOP.

### SUMMARY OF THE INVENTION

The present disclosure provides a process for the preparation of the treated water fortified with the micro nutrients comprising:
pre-treating and sterilizing the water, resulting in a pure permeate;
ozonating said permeate for further sterilizing the water;
de-ozonating said permeate after holding it for the required time to produce on line sterile water; and
dosing at least one bio-available micro nutrient and/or sanitizing agent into the flowing water on line.

The above process further comprises monitoring of online parameters during run production against control drink preparation standards.

The step of monitoring of online parameters during run production against control drink preparation standards comprises setting up the line monitoring standard to run according to the control drink TDS (Total dissolved Solids).

The Control drink TDS is a parameter of control drink which is measured by the following steps:
preparing a batch of three control drinks each of volume upto 1 litre with de-ozonated permeate at the time of blending the concentrates, two of which must be from concentrate sampled from different sampling points of the blending vessel;
diluting the blended concentrate in each control drink to 111 times its volume with de-ozonated permeate during the time of blending;
stirring for mixing properly and stabilizing the batch;
measuring the TDS of the batch, which is the average of the three Control Drink TDS values.

The line monitoring standard for TDS is the sum of TDS of de-ozonated RO permeate and TDS due to concentrate with a variation of +/−10 percent.

The step of monitoring of online parameters during run production against control drink TDS includes verifying that the product TDS matches with the control drink TDS.

This process involves effective treatment and sterilization of water without having to use chemicals or long storage. This method reduces the risks of the water and also provides a consistent base characteristic on which the composition can enhance to achieve the desired nutritional characteristics.

### BRIEF DESCRIPTION OF THE DRAWINGS

It is to be noted, however, that the appended drawing illustrates only typical embodiment of this invention and are therefore not to be considered for limiting of its scope, for the invention may admit to other equally effective embodiments.

FIG. 1 shows the flow chart for the preparation of treated water fortified with the micro nutrients, according to the present disclosure.

FIG. 2 shows the detailed flow chart of a specific embodiment of the water treatment process, according to the present disclosure.

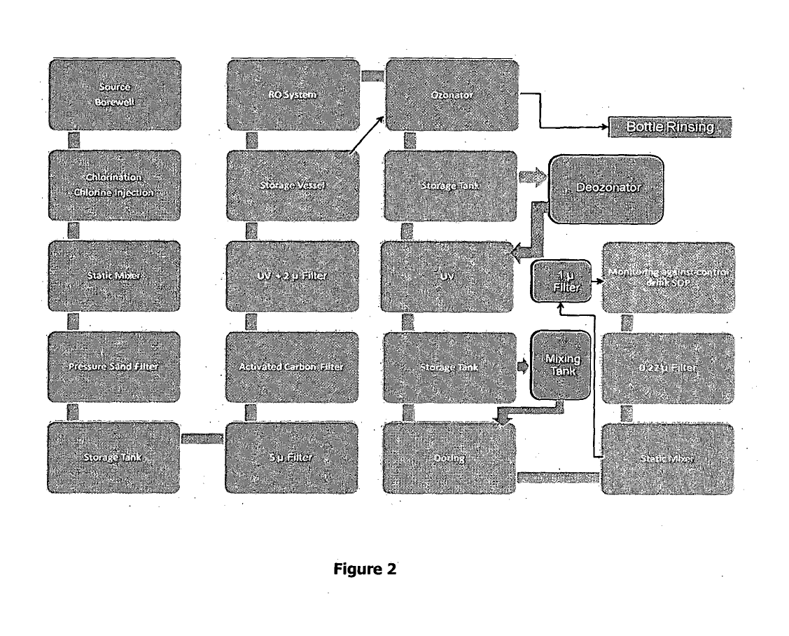

### DETAILED DESCRIPTION OF THE INVENTION

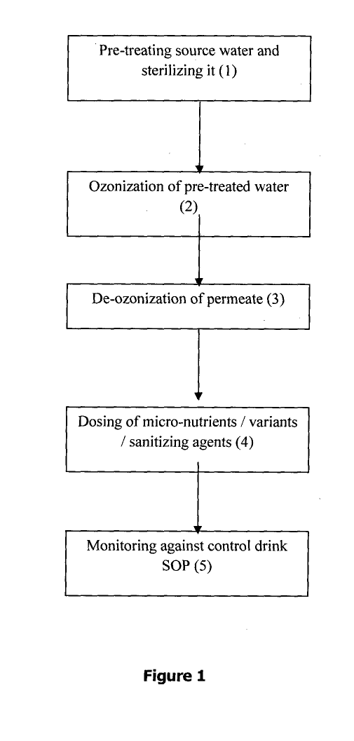

Referring to FIGS. 1 & 2, it illustrates the preferred embodiment of process for the preparation of the treated water fortified with the micro-nutrients to supplement the deficiencies. The process steps are described as below in detail.

### (1) Pre-Treating and Sterilizing the Water

The source water is treated by chlorination and keeping if for a sufficiently long time in a tank to make it microbiologically safe for consumption.

The pre-treated water is filtered for removing the dirt and other physical impurities and passed through Activated Carbon Filter for removing any odorous or colored matter from the water besides absorbing any excess chemicals, such as chlorine. The said filtered water is further sterilized by passing it through a suitable intensity Ultra Violet lamp. Further, the sterilized water is dosed with anti-scalant and pH adjusting chemicals. The water may be passed through a 5 micron and a 1 micron filter assembly to remove all dead microbes and any insoluble chemicals, resulting in a pure permeate.

### (2) Ozonization

Before ozonization, the permeate may be passed through the RO membranes where it is stripped of all constituents, including most ions.

Thereafter, the water is further disinfected by passing Ozone through the RO permeate. The ozone level is maintained between 0.1 to 0.3 ppm at all points. This ozone level is sufficient to sterilize the water without increasing the residual ozone to values where it may react with other constituents of water and also require more energy to break down or de-ozonate. The ozonation is done by an ozonator, which creates the ozone after concentration of oxygen.

### (3) De-Ozonization

In the next step, the ozonated water is de-ozonated after holding it for the required time and passing through ultraviolet ozone destruct unit to produce online sterile water.

The de-ozonator ensures removal of ozone on line by a high intensity UV light, which does not allow residual ozone to remain in the'water and react with the micro-nutrients which are dosed on line. The UV also doubles up as a secondary method of sterilization of the water before dosing of the micro-nutrients.

### (4) Dosing System

Care must be taken for proper sanitization of the dosing system.

Proper mixing batch is prepared as per mixing batch preparation protocol of the variant.

The dosing solution is prepared by adding the concentrate and blending with the pre-determined amount of water. The dosing solution is tested for clarity, turbidity, colour, TDS and pH.

The filler speed required for the run is calculated, which further determines the flow rate required from the RO and the rate of dosing. Thus, the operating parameters like filler speed, RO permeate flow rate and dosing pump setting should be appropriate and set to match the ozonator capacity and the UV lamp intensity of the de-ozonator, i.e. the de-ozonator capacity.

The product flow rate and TDS must be monitored at fixed regular intervals.

Without limitation, the concentrate required for preparing the dosing solution may be the composition of micronutrients/variants, as claimed in our co-pending patent application nos. 1071/KOL/2010; 1072/KOL/2010, 1068/KOL/2010 and 1070/KOL/2010.

Thus, the combination of the micro-nutrients complements each other while permitting a water neutral product to result.

The chemicals used in the water neutral beverage are selected in a manner as to be compatible with water such that they do not have any odour, the composition does not precipitate or reacts or sediments. Also, the shelf life of the elements has been so maintained in the composition that the composition does not degrade when used with water. Said effects are the result of the synergistic effect among the ingredients of the composition.

### (5) Monitoring Against Control Drink Sop

The monitoring of online parameters during run production against control drink preparation standards comprises setting the line to run according to the control drink TDS (Total dissolved Solids).

The Control drink TDS is a parameter of control drink which is measured by the following steps:
preparing a batch of three control drinks each of volume upto 1 litre with de-ozonated permeate at the time of blending the concentrates, two of which must be from concentrate sampled from bottom and middle sampling points of the blending vessel;
diluting the blended concentrate in each control drink to 111 times its volume with de-ozonated permeate during the time of blending;
stirring for mixing properly and stabilizing the batch;
measuring the TDS of the batch, which is the average of the three Control Drink TDS values that is consistent with each other.

If control drink TDS is varying widely from each other, it indicates that further blending of 15 minutes is required before re-sampling. In case the variation is independent of the sampling points, but the above variation exists, then repeat the control drink preparation until consistent values are obtained.

The TDS of the de-ozonated RO permeate is subtracted from the control drink TDS. This is termed delta TDS for the run production. The line TDS target on line and operating window is the sum of the de-ozonated RO permeate and the delta TDS with a variation of +/−10 percent on the delta TDS value.

Further, the control drink is regularly analyzed for actives as per variant/micro-nutrients such as copper, calcium, zinc, boron etc.

### Finished Product

Thus, the above treated and fortified water must adhere to the following parameters

| | |
|---|---|
| Taste & Odor | Free from off odor/taste |
| Appearance | Free from foreign particles |
| Beverage pH | Product specific as per Mixing Instruction |
| Turbidity | Not more than 2 NTU |
| Total Dissolved Sol | As per Control Drink SOP |
| Microbiological Tests | 0 per 250 ml Yeast & Mold |
| (TC, Y&M) | Absence of coliform, E. Coli, P. aureginosa, |
| | Sulphite reducing anaerobes |
| Calcium, Copper, | As per specifications of dosing |
| Zinc, Boron, Etc. | |
| Net Content | +/−1.5% (average of reading should be not be |
| | lower than the declared quantity) for 750 ml |
| | bottles and +/−2.5% for 200 ml pouches |
| Alkalinity | Must pass specifications |
| Torque | Torque Value shall be 12 +/− 2 |

This process involves effective treatment and sterilization of water without having to use chemicals or long storage. This method reduces the risks of the water and also provides a consistent base characteristic on which the composition can enhance to achieve the desired nutritional characteristics.

It is to be noted that the present invention is susceptible to modifications, adaptations and changes by those skilled in the art. Such variant embodiments employing the concepts and features of this invention are intended to be within the scope of the present invention, which is further set forth under the following claims.

1. A process for the preparation of treated water fortified with micro-nutrients comprising:
pre-treating and sterilizing the water, resulting in a pure permeate;
ozonating said permeate for further sterilizing the water;
de-ozonating the permeate to remove ozone, thereby producing on line sterile water; and
dosing at least one bio-available micro-nutrient and/or sanitizing agent into the flowing water on line

2. The process as claimed in claim 1, further comprising monitoring of online parameters during run production against control drink preparation standards.

3. The process as claimed in claim 1, wherein before the step of ozonization, the permeate is optionally passed through the RO membranes where it is stripped of all constituents, including most ions.

4. The process as claimed in claim 2, wherein the step of monitoring of online parameters during run production against control drink preparation standards comprises setting up the line monitoring standard to run according to the control drink TDS (Total dissolved Solids).

5. The process as claimed in claim 4, wherein the control drink TDS is a characteristic of control drink which is measured by the following steps:
preparing a batch of three control drinks each of volume up to 1 litre with de-ozonated permeate at the time of blending the concentrates, two of which must be from concentrate sampled from different sampling points of the blending vessel;
diluting the blended concentrate in each control drink to 111 times its volume with de-ozonated permeate during the time of blending;
stirring for mixing properly and stabilizing the batch;
measuring the TDS of the batch, which is the average of the three Control Drink TDS values that is consistent with each other.

6. The process as claimed in claim 4, wherein the line monitoring standard for TDS is the sum of TDS of de-ozonated permeate and TDS due to concentrate with a variation of +/−10 percent.

7. The process as claimed in claim 2, wherein the step of monitoring of online parameters during run production against control drink TDS includes verifying that the product TDS matches with the control drink TDS.

8. The process as claimed in claim 5, wherein if control drink TDS is varying widely from each other, it indicates that further blending of 15 minutes is required before re-sampling.

9. Treated water fortified with micro nutrients prepared according to the process of claim 1.

10. The process for the preparation of the treated water fortified with micro-nutrients substantially as herein described with reference to and as illustrated in the accompanying drawings.

11. Treated water fortified with micro nutrients prepared according to the process of claim 2.

12. Treated water fortified with micro nutrients prepared according to the process of claim 3.

13. Treated water fortified with micro nutrients prepared according to the process of claim 4.

14. Treated water fortified with micro nutrients prepared according to the process of claim 5.

15. Treated water fortified with micro nutrients prepared according to the process of claim 6.

16. Treated water fortified with micro nutrients prepared according to the process of claim 7.

17. Treated water fortified with micro nutrients prepared according to the process of claim 8.
